(19) United States
(12) Patent Application Publication
(10) Pub. No.: US 2021/0088047 A1
(43) Pub. Date: Mar. 25, 2021

(54) SCROLL PUMP AND SCROLL PUMP ANTI-ROTATION DEVICE

(71) Applicant: Edwards Limited, Burgess Hill (GB)

(72) Inventors: Richard Percival-Alwyn, Burgess Hill (GB); Matthew Paul Reynolds, Burgess Hill (GB)

(21) Appl. No.: 16/772,288

(22) PCT Filed: Dec. 19, 2018
(86) PCT No.: PCT/GB2018/053686

§ 371 Date: Jun. 12, 2020

(30) Foreign Application Priority Data
Dec. 22, 2017 (GB) 1721826.4

(51) Int. Cl. F04C 18/02; F04C 29/00

(52) U.S. Cl. CPC F04C 18/0215; F01C 17/066; F04C 29/0057

(57) ABSTRACT

A scroll pump anti-rotation device for resisting relative rotational movement between two scrolls and a scroll pump comprising such a device is disclosed. The anti-rotation device comprises: an elongate member forming an inner ring; an elongate member forming an outer ring surrounding the inner ring; a plurality of connecting members extending between adjacent elongate members; and at least one fixing point for fixing the outer ring to the scroll pump in a fixed relation to one of the scrolls and at least one further fixing point for fixing the inner ring to the scroll pump in a fixed relation to the other of the scrolls.

This application is a national stage entry under 35 U.S.C. § 371 of International Application No. PCT/GB2018/053686, filed Dec. 19, 2018, which claims the benefit of GB Application 1721826.4, filed Dec. 22, 2017. The entire contents of International Application No. PCT/GB2018/053686 and GB Application 1721826.4 are incorporated herein by reference.

### TECHNICAL FIELD

The field of the disclosure relates to scroll pumps and to scroll pump anti-rotation devices.

### BACKGROUND

A scroll pump comprises two interleaving scrolls one of which has an orbital motion with respect to the other thereby trapping and pumping or compressing pockets of fluid between the scrolls. In some cases, one of the scrolls is fixed, while the other is mounted on a drive shaft with an eccentric cam such that it orbits eccentrically without rotating. Another method for producing the relative orbiting motion is by co-rotating the scrolls, in synchronous motion, but with offset axes of rotation. Thus, the two scrolls are mounted on parallel shafts and the relative motion is the same as if one were orbiting and the other stationary.

In the case of fixed and orbiting scrolls an anti-rotation device may be used connected to the scrolls to resist relative rotation between them and thereby allowing the radial clearances to be accurately maintained as the scrolls pump. The anti-rotation device should resist rotational movement but also allow the relative orbiting motion required for the pumping. In the case of co-rotating scrolls, such a device can be used to transmit a drive force from one scroll to the other, in a similar way to a pair of gears or a drive belt and pulleys.

A bellows arrangement formed from a crimped pipe has been used as an anti-rotation device in a fixed and orbiting scroll pump. This arrangement is located on the orbiting scroll side of the pump and resists rotation of the orbiting scroll but is sufficiently flexible to allow the orbiting motion.

A drawback of such a device is that the bellows need to be quite long to limit stress in the bellows below fatigue limits, and thus, pumps with bellows are physically quite big for their displacement. An alternative more compact anti-rotation arrangement is disclosed in WO2011/135324. The anti-rotation device here comprises a central body portion from which two perpendicular pairs of arms extend, a first pair being connected to the fixed scroll and a second pair to the orbiting scroll, the first pair flexing to allow movement of the orbiting scroll relative to the fixed scroll in a first direction and the second pair flexing to allow movement of the orbiting scroll in a second orthogonal direction. This provides a more compact arrangement than the bellows, but it has proved difficult to scale up, because there are only two pairs of legs to share the stresses, and there is a significant unbalanced mass which introduces vibration to the pump.

It would be desirable to provide a scroll pump and scroll pump anti-rotation device, where the anti-rotation device is compact, robust and provides effective relative rotational resistance, while allowing relative orbiting motion between scrolls.

### SUMMARY

A first aspect provides a scroll pump anti-rotation device for resisting relative rotational movement between two scrolls, said anti-rotation device comprising: an elongate member forming an inner ring; an elongate member forming an outer ring surrounding said inner ring; a plurality of connecting members extending between adjacent elongate members; and at least one fixing point for fixing said outer ring to said scroll pump in a fixed relation to one of said scrolls and at least one further fixing point for fixing said inner ring to said scroll pump in a fixed relation to the other of said scrolls.

Scroll pumps provide two interleaving scrolls which pump fluids by providing relative motion between the scrolls which means the distance between scrolls changes as one of the scrolls orbits and the fluid is pumped through the device. This relative orbiting motion may be produced by one scroll being fixed and the other orbiting eccentrically or by both scrolls rotating in synchronous motion but with offset but parallel axes of rotation. The radial clearances between the two scrolls are accurately controlled and it is therefore important that relative rotation between the scrolls is resisted while translational movement which allows the orbiting motion is permitted. Embodiments seek to provide a compact scroll pump anti-rotation device that resists relative rotational movement between the two scrolls in an effective manner. The anti-rotation device is formed from two elongate members which form an inner and outer ring mounted one within the other and which have a plurality of connecting members extending between each adjacent elongate member. These inner and outer elongate members are fixed via fixing points to the two scrolls. In this regard, the inner and outer elongate members may be fixed directly to respective scrolls or they may be fixed to a member on the pump that is in fixed relation to the scrolls. In any case they are fixed such that the fixing points follow the movement of the scroll to which it is fixed.

The fixing points may be directly on the inner and outer elongate members or they may be on more robust parts of the anti-rotation device which are themselves connected to the inner and outer elongate members. Thus, the fixing points may be an outer support ring and/or an inner portion of the anti-rotation device, the outer support ring being connected to the outer elongate member and the inner portion being connected to the inner elongate member. In either case, the anti-rotation device is configured such that forces provoked by relative motion between the two scrolls are transmitted between the fixing points through the elongate and connecting members. Rotational motion is substantially parallel to the elongate members and is resisted by tensile forces with little displacement. Translational motion is substantially perpendicular to the elongate members and is resisted by much smaller bending forces which permit a large displacement.

The elongate members that form the rings may be formed from a band of material that has two continuous sides, and two edges and is in effect looped round to attach to itself and thus forms a loop, hoop or a ring. As the elongate member forms a ring it can resist tangential forces which act substantially along the material and thus, act to compress or stretch it, but is more flexible in response to radial forces which act in a substantially perpendicular direction to the material. In this way a compact, cost effective and yet efficient way of resisting relative rotational movement while allowing relative orbiting motion between the scrolls is provided.

Although, the scroll pump anti-rotation device may be formed with just two elongate members forming an inner and outer ring, in some embodiments it comprises at least one further elongate member extending around the inner ring and located between the inner and outer ring. In yet other embodiments, it comprises a plurality of further elongate members located at different positions between the inner and outer ring. The more elongate members that are provided the more robust the anti-rotation device. The number of elongate members may be selected according to the properties required. These properties include resistance to relative rotational movement and flexibility to relative orbital motion, along with robustness and corresponding resistance to wear.

Although the elongate members may have a number of forms provided that they form some sort of ring or loop, in some embodiments the elongate members have a circular ring form, while in others they may have a polygonal form.

The polygonal ring form may have curved arcs between the angles of the polygon or it may have straight sides between the angles of the polygon. In this regard, the actual shape of the elongate members is selected dependent on the properties required and the manufacturing techniques available. A straight edge between angles of a polygon provides an anti-rotation device which is more robust in a tangential direction and therefore resists relative rotation better than one with curved sides. In effect it is more angularly stiff such that it resists relative rotation better.

Where both scrolls are rotating with offset axes the anti-rotation device may be used to transmit torque effectively between the scrolls.

In some embodiments, said plurality of elongate members comprise rings of a same polygonal form.

Although the rings may have different forms, generally they will be formed of a same shape and where they are polygons they will have the same polygonal form such that they fit neatly one within the other.

In some embodiments, said connecting members join to elongate members at nodes.

In some embodiments, said nodes are located on said elongate members at the angles of the polygon.

It may be advantageous if the connecting members adjoin the elongate members at the angles or corners of the polygon. Such an arrangement may be robust and easy to manufacture.

In some embodiments a line perpendicular to the radius of the ring at the node will pass between the connecting member and the angled side of the elongate member extending from the node in the direction of the connecting member and in some embodiments this tangent will bisect this angle. Providing elongate and connecting members that are angled around a tangent, means that although the connecting members extend towards the adjacent elongate member they only have a low radial component to their direction, such that any radial stability provided by the connecting member is low. Thus, such an anti-rotation device is radially flexible while being angularly stiff

In some embodiments, said elongate members are configured to deform under a radial force and to resist a tangential force. In particular, the portion between nodes may be particularly easy to deform in a radial direction.

By having an elongate member which is supported by connection to another elongate member at several connecting members, the portion of the elongate member between the connecting members may be configured to deform under a radial force and yet still resist any tangential force as it forms a loop. The connecting members act to transfer forces between the elongate members and may, depending on the direction in which they extend, provide some radial stability. Where there is substantial angular stiffness, the anti-rotation device provides an effective way of transmitting torque from the inner to the outer ring.

In some embodiments, said connecting members at adjacent nodes are angled alternately by obtuse and acute angles with respect to said elongate member from which they extend.

Arranging connecting members angled in this way provides a structure where the members can compress together and expand apart from each other radially, allowing radial movement between inner and outer elongate members. In effect, in some embodiments a spiral shape is formed when moving from one elongate member to another along the angled connecting members between the inner and outer rings.

In other embodiments, said connecting members are radially extending connecting members and are offset with respect to each other on any radius.

Where the connecting members are radially extending connecting members, then in some embodiments they are offset angularly with respect to each other such that in effect they form staggered spokes around the anti-rotation device such that there is not a set of connecting members which extend along a complete radius, such an arrangement is to be avoided as it would provide high translational stiffness. Translational stiffness is to be reduced where possible to allow translational movement of one scroll with respect to the other, thereby allowing relative orbital motion while resisting relative rotation motion. Thus, the inner and outer rings are configured not to be connected along a single radius and where the connecting members are radially extending connecting members then they are staggered with respect to each other.

In some embodiments, said elongate members when not under stress comprise concentric rings.

The elongate members may be formed of concentric rings when not under stress and when under radial stress these will deform and allow some radial motion while resisting rotation motion.

In some embodiments the scroll pump anti-rotation device comprises six or few connecting members connecting adjacent elongate members, preferably four or fewer connecting members.

In this regard, some radial movement of the rings with respect to each other is desirable and by providing a limited number of connecting members the elongate members are longer between adjacent connecting members and thus can flex in the radial direction allowing improved radial movement. Where the connecting members are themselves angled to follow a substantially tangential line (that is one perpendicular to a radius of the device) or at least one offset by less than 20. to the tangent, then the radial stiffness provided by the connecting members is low and additional connecting members may provide an anti-rotation device with acceptable properties.

In some embodiments, the scroll pump anti-rotation device has a planar disc or wheel form. This is a compact form and allows for a compact scroll pump.

Although the scroll pump anti-rotation device can be formed of a number of different materials provided that the elongate members have some flexibility, in some embodiments it is formed of plastic.

Plastic is low cost, robust, easy to manufacture, flexible material which withstands corrosion and is relatively unreactive making it a good material for this device. Furthermore the simple two dimensional profile of the anti-rotation device makes it easy to manufacture using low cost manufacturing techniques such as laser cut/water jet techniques.

In some embodiments, the scroll pump anti-rotation device further comprises

an outer support ring, said outer support ring being thicker and less flexible than said elongate members, and comprising at least one of said fixing points.

Although the fixing points can have a number of different forms, in some embodiments there is an outer support ring which is connected to the outer elongate member and provides a robust setting for the fixing points to one of the scrolls.

In some embodiments, the anti-rotation device comprises an inner portion connected to the inner ring and comprising the other at least one fixing point. In this regard, the fixing points may simply be holes through which bolts or screws may be attached for attaching the anti-rotation device to the respective scroll.

In some embodiments, the inner portion comprises a circular disc. In other embodiments the inner portion comprises a plurality of radially extending members.

A second aspect of the present disclosure provides a scroll pump comprising a pump housing, an orbiting scroll and a fixed scroll, a central drive shaft having an eccentric shaft portion connected to said orbiting scroll for driving said orbiting scroll in an orbiting motion relative to said fixed scroll, and an anti-rotation device according to a first aspect connected in a fixed relation to said fixed and orbiting scrolls for resisting rotation of said orbiting scroll while allowing said orbiting motion.

A third aspect of the present disclosure provides a scroll pump comprising a pump housing, two rotating scrolls mounted on offset parallel axes, a drive shaft for driving one of said scrolls, and an anti-rotation device according to a first aspect connected in a fixed relation to said one of said scrolls and to the other of said scrolls, such that said two scrolls rotate in synchronisation with each other.

In some embodiments, said anti-rotation device is operable to transmit torque from one scroll to the other scroll and to resist relative angular rotation of said two scrolls.

Further particular and preferred aspects are set out in the accompanying independent and dependent claims. Features of the dependent claims may be combined with features of the independent claims as appropriate, and in combinations other than those explicitly set out in the claims.

Where an apparatus feature is described as being operable to provide a function, it will be appreciated that this includes an apparatus feature which provides that function or which is adapted or configured to provide that function.

### BRIEF DESCRIPTION OF THE DRAWINGS

Embodiments of the present disclosure will now be described further, with reference to the accompanying drawings.

FIGS. 1 to 3 illustrate different examples of anti-rotation devices according to different embodiments.

FIG. 4 shows a scroll pump comprising an anti-rotation device according to an embodiment.

### DETAILED DESCRIPTION

Before discussing the embodiments in any more detail, first an overview will be provided.

An anti-rotation device for a scroll pump is provided having elongate members in the form of bands which loop round such that the band comprises two opposing continuous surfaces and two edge surfaces connecting the two opposing surfaces. In use, the elongate members are arranged around the centre of rotation of the scroll(s) and any rotational forces between the scrolls, or at least the major component of these rotational forces act along the material forming the elongate members and thus, act as compression or tension forces on the material, which forces can thereby be effectively resisted by the material. Radial forces due to translational movement of one of the scrolls relative to the other act in a perpendicular direction to the material of the elongate member, or at least a major component of such forces do. Resistance to these forces is low compared to the resistance to the rotational forces, as the forces do not act along the material and the elongate material is able to move and flex in response to these forces.

In this way a device operating on similar principles to the device of WO2011/135324 is provided which in some embodiments has a plurality of elongate members to share the loads, thereby increasing robustness. Furthermore, the device does not require the same rigid framework required in WO2011/135324 to support the flexible elongate members, thus, the device can be lighter, and therefore easier to balance. In this regard, as the rigid framework reciprocates rather than following an orbit it does not have a spinning weight counterbalance.

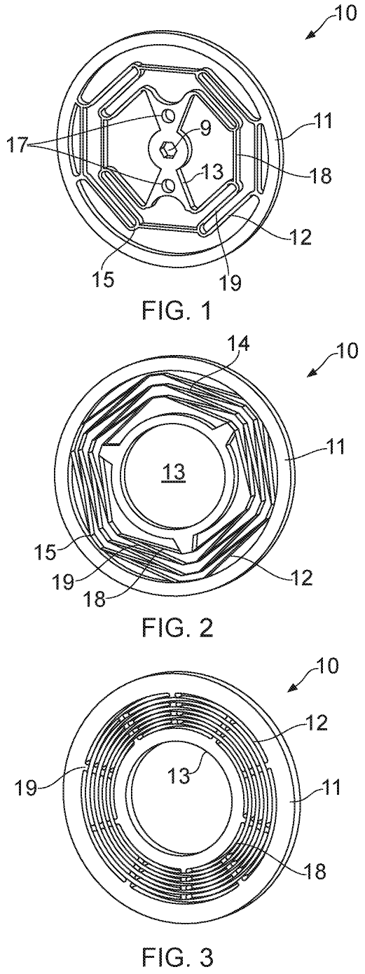

There are a number of different designs for such an anti-rotation device, FIGS. 1 to 3, providing just three examples. The important principle is that several generally “annular” concentric rings (which may be circular, may be polygonal, or may be a combination of both) are connected by staggered radial or angled spokes.

Torque is transmitted from the inner hub to the outer rim through tension in the annular parts, and the “radial” parts (being in some embodiments only short sections between adjacent annular parts) resist bending. Therefore, the angular displacement per unit torque is low. Under radial force, the longer “annular” parts are subject to bending forces, and the shorter “radial” elements are in tension or compression. The design is flexible allowing linear displacement of the inner and outer elongate members in the plane of the device.

The underlying principle is that elongated features are stiff when pulled but are easy to bend, to provide torsional stiffness but lateral compliance.

Such a device thereby provides an effective anti-rotation device. This device may be used to provide stability and control of the radial clearances between scrolls of a scroll pump with fixed and orbiting scrolls. It may also be used in scroll pumps where both scrolls rotate about offset axes as a torque transmission device. In such a case, one of the scrolls may be mounted on a drive shaft and the other may mounted to rotate about a shaft that is not driven. Driving of the non-driven scroll may be provided via the anti-rotation device which acts to transmit torque from one scroll to the other. The properties of high resistance to relative rotational movement but low resistance to relative orbital motion makes this device particularly effective in this role. Furthermore, it is a more cost effective solution that requires less maintenance than the alternative solution of providing gears to drive the second shaft, or providing two drive motors.

FIG. 1 shows an example of an anti-rotation device 10 according to an embodiment. The anti-rotation device 10 comprises an outer support ring 11, which comprises fixing points (not shown) to fix the device to one of the scrolls. The fixing points may comprise apertures through which a bolt may be mounted, or they may comprise some other means which may be used in association with other attaching means to attach the outer support ring and thereby the outer elongate member 12 of the anti-rotation device to one of the scrolls.

Outer elongate member 12 has a ring form arranged around the centre of rotation 9. It is attached to the outer support ring 11 at four points, and is connected to an inner elongate member 18, via four connecting members 19. The connecting members 19 meet the elongate members 12, 18 at nodes 15. In this embodiment the connecting members 19 are angled such that a line perpendicular to a radius of the device, the radius passing through the centre of rotation 9, bisects the angle between the elongate member and connecting member.

In this embodiment the inner elongate member, is formed of elongate portions and a section of the inner portion 13 of the anti-rotation device 10. This inner portion 13 comprises fixing points 17 in the form of holes for receiving bolts to attach the anti-rotation device to the other of the scrolls. In this way the outer elongate member 12 is fixed via the outer support ring 11 to one of the scrolls and the inner elongate member 18 is fixed via the inner portion 13 to the other of the scrolls when mounted on the scroll pump. Thus, relative movement of the scrolls will be transmitted through the inner and outer elongate members of the anti-rotation device, and its configuration is such that relative rotational forces which will act substantially along the elongate members and will be resisted, while translational forces acting substantially at right angles to the elongate members will experience a much lower resistance.

FIG. 2 shows an alternative embodiment, wherein the inner portion 13 comprises an inner support ring, concentric to the outer support ring 11. In this embodiment there are three elongate members, 12, 14 and 18 and these are joined via connecting members 19, which extend from the elongate members at nodes 15. The elongate members form concentric hexagonal polygons with straight sides between nodes 15. There are six connecting members angled such that a tangent to a circle around the centre of rotation bisects the angle between connecting members and elongate members. At alternate nodes, the connecting members extend in opposite directions. In this way a device is provided where the inner ring 13 can move within the outer ring 11 by flexing of the elongate members, but cannot rotate with respect to it.

FIG. 3 shows a further embodiment, comprising inner and outer support rings, 13, 11 between which eight concentric rings forming eight elongate members are located. Each elongate member is connected to at least one adjacent elongate member and the inner and outer elongate members are connected to the inner and outer support rings, via five radial spokes. The radial spokes extending from adjacent elongate members are offset with respect to each other. In this way radial motion of the inner ring with respect to the outer ring is allowed as there is no continuous radial spoke, while relative rotational motion is resisted.

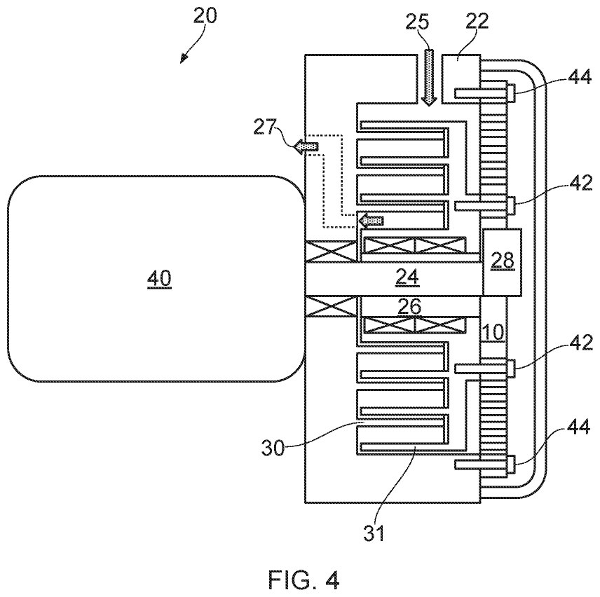

FIG. 4 schematically shows a scroll pump 20 according to an embodiment, comprising anti-rotation device 10 mounted with the inner elongate member connected to orbiting scroll 31 and the outer elongate member connected to fixed scroll 30.

It would be clear to a skilled person that this is simply an example embodiment and the inner elongate member could be connected to the fixed scroll and the outer elongate members to the orbiting scroll. Furthermore, in a further embodiment, the scroll pump may comprise two rotating scrolls with offset axes and in such a case the anti-rotation device would be mounted in a similar manner to the above, but with the inner and outer elongate members being fixed to respective ones of the two rotating scrolls. In each case forces due to relative motion of the two scrolls are transmitted from the inner to outer elongate members of the anti-rotation device via intermediate elongate and connecting members.

Scroll pump 20 comprises a pump housing 22 and a drive shaft 24 having an eccentric cam 26. The drive shaft 24 is driven by a motor 40 and the eccentric cam 26 is connected to an orbiting scroll 31 so that during use rotation of the drive shaft imparts an orbiting motion to the orbiting scroll relative to a fixed scroll 30. The orbiting motion pumps fluid along a fluid flow path between a pump inlet 25 and pump outlet 27. The fixed scroll 30 is shown generally on the left and the orbiting scroll 31 is shown generally on the right in FIG. 4.

In this arrangement, the fixed scroll comprises an opening through which the shaft 24 extends. The shaft is connected to the orbiting scroll 31 on an opposing side of the fixed scroll to the motor 40. A high vacuum region is located at the inlet 25 and a low vacuum, or atmospheric, region is located at the outlet 27.

A counter-weight 28 balances the weight of the orbiting components of the pump, including the orbiting scroll 31, and the eccentric portion of the drive shaft. The orbiting scroll 31 constitutes the majority of the weight of the orbiting components and its centre of mass is located relatively close to the scroll plate of the orbiting scroll.

An anti-rotation device 10 according to an embodiment, such as is shown in FIGS. 1 to 3, is located in the high vacuum region of the pump and in this embodiment, the inner portion is connected to the orbiting scroll 31 via bolts 42 which pass through holes on the inner portion of the anti-rotation device. The outer support ring is connected to the pump housing 22, which is in a fixed relation to the fixed scroll. Thus, the outer support ring and the fixed scroll stay fixed together while the inner portion moves with the orbiting scroll. The anti-rotation device 10 provides high resistance to relative rotational movement between the two scrolls and significantly lower resistance to the orbiting motion.

The anti-rotation device is lubricant free and in this example is made from a plastics material, and may be a one-piece polymer component.

Although illustrative embodiments of the disclosure have been disclosed in detail herein, with reference to the accompanying drawings, it is understood that the disclosure is not limited to the precise embodiment and that various changes and modifications can be effected therein by one skilled in the art without departing from the scope of the disclosure as defined by the appended claims and their equivalents.

1. A scroll pump anti-rotation device configured to resist relative rotational movement between two scrolls, the anti-rotation device comprising:
a first elongate member forming an inner ring;
a second elongate member forming an outer ring surrounding the inner ring;
a plurality of connecting members extending between adjacent first and second elongate members; and
at least one fixing point configured to fix the outer ring to the scroll pump in a fixed relation to one of the two scrolls and at least one further fixing point for fixing the inner ring to the scroll pump in a fixed relation to the other of the two scrolls.

2. The scroll pump anti-rotation device according to claim 1, further comprising at least one further elongate member extending around the inner ring and located between the inner and outer rings.

3. The scroll pump anti-rotation device according to claim 1, further comprising a plurality of further elongate members each extending around the inner ring and located at different positions between the inner and outer rings.

4. The scroll pump anti-rotation device according to claim 1, wherein at least one of the first or second elongate members has a circular ring form.

5. The scroll pump anti-rotation device according to claim 1, wherein at least one of the first or second elongate members has a polygonal ring form.

6. The scroll pump anti-rotation device according to claim 5, wherein the polygonal ring form comprises a ring with curved arcs between angles of the polygon ring form.

7. The scroll pump anti-rotation device according to claim 5, wherein the polygonal ring form comprises a ring with straight edges between angles of the polygon ring form.

8. The scroll pump anti-rotation device according claim 5, wherein the first and second elongate members comprise rings of a same polygonal shape.

9. The scroll pump anti-rotation device according to claim 5, wherein the plurality of connecting members join to the first and second elongate members at nodes.

10. The scroll pump anti-rotation device according to claim 9, wherein the nodes are located on the elongate members at the angles of the polygon ring form.

11. The scroll pump according to claim 9, wherein the first and second elongate members are configured between the nodes to deform under a radial force and to resist a tangential force.

12. The scroll pump according to claim 9, wherein the plurality of connecting members at adjacent nodes are angled alternately by obtuse and acute angles with respect to the first or second elongate member from which the plurality of connecting members extend.

13. The scroll pump anti-rotation device according to claim 1, wherein the plurality of connecting members are radially extending connecting members and connecting members extending from adjacent elongate members are offset with respect to each other on any radius.

14. The scroll pump anti-rotation device according to claim 1, wherein the first and second elongate members when not under stress comprise concentric rings.

15. The scroll pump anti-rotation device according to claim 1, comprising six or fewer connecting members connecting the first and second elongate members.

16. The scroll pump anti-rotation device according to claim 15, comprising four or fewer connecting members connecting the first and second elongate members.

17. The scroll pump anti-rotation device according to claim 15, the scroll pump anti-rotation device having a planar disk form.

18. The scroll pump anti-rotation device according to claim 15, wherein the scroll pump anti-rotation device is formed of plastic.

19. The scroll pump anti-rotation device according to claim 15, comprising an outer support ring, the outer support ring being thicker and less flexible than the elongate members, and comprising at least one of the fixing points.

20. The scroll pump anti-rotation device according to claim 15, comprising an inner portion, an intermediate portion and the outer ring, the inner portion being formed of at least one member and the intermediate portion being formed of a plurality of elongate and connecting members, the plurality of elongate and connecting members being narrower and more flexible than the at least one member of the inner portion.

21. The scroll pump anti-rotation device according to claim 20, wherein the inner portion comprises a circular disk.

22. The scroll pump anti-rotation device according to claim 20, wherein the inner portion comprises a plurality of radially extending members.

23. A scroll pump comprising:
a pump housing;
an orbiting scroll; and
a fixed scroll;
a central drive shaft having an eccentric shaft portion connected to the orbiting scroll for driving the orbiting scroll in an orbiting motion relative to the fixed scroll; and
the anti-rotation device according to claim 1 connected in a fixed relation to the fixed and orbiting scrolls for resisting rotation of the orbiting scroll while allowing the orbiting motion.

24. A scroll pump comprising:
a pump housing;
two rotating scrolls mounted on offset parallel axes;
a drive shaft for driving one of the two rotating scrolls; and
the anti-rotation device according to claim 1 connected in a fixed relation to the one of the two rotating scrolls and to the other of the two rotating scrolls, such that the two scrolls rotate in synchronization with each other.

25. The scroll pump according to claim 24, wherein the anti-rotation device is operable to transmit torque from the one scroll to the other scroll and to resist relative angular rotation of the two scrolls.
